(19) United States
(12) Patent Application Publication
(10) Pub. No.: US 2022/0351876 A1
(43) Pub. Date: Nov. 3, 2022

(54) ACRYLIC CONDUCTIVE PASTE FOR SEMICONDUCTOR DEVICE AND METHODS

(71) Applicant: Soltrium Advanced Materials Technology, Ltd., Shenzhen (CN)

(72) Inventors: Weiteng Feng, Shenzhen (CN); Fengzhen Sun, Shenzhen (CN); Delin LI, San Jose, CA (US)

(21) Appl. No.: 17/413,563

(22) PCT Filed: Jan. 17, 2020
(86) PCT No.: PCT/CN2020/072637

§ 371 Date: Jun. 13, 2021

(51) Int. Cl. H01B 1/22; C08K 3/08; C08K 7/18

(52) U.S. Cl. CPC H01B 1/22; C08K 3/08; C08K 7/18; C08K 2003/0806; C08K 2003/085; C08K 2201/006; C08K 2201/001

(57) ABSTRACT

An acrylic conductive paste is provided, based on 100 parts by weight, including: 30-84 parts of conductive particles, 15˜45 parts of acrylate, 0.5˜2.5 parts of adhesion promoter, 0.5˜3 parts of initiator. The conductive particles include three-dimensional dendritic conductive particles; and the adhesion promoter is a mixture of a silane coupling agent and a phosphate ester. The conductive paste of the present disclosure has good electrical conductivity, short curing time, strong adhesion, and can be used for a long-time room temperature operation. The present disclosure also provides a method for preparing the above-mentioned acrylic conductive paste, which is convenient for operation and industrial application; at the same time, it shows that the acrylic conductive paste of the present disclosure can be applied to semiconductor components for packaging a semiconductor device.

### CROSS-REFERENCES TO RELATED APPLICATIONS

This application is a national-phase application of and claims priority to PCT Patent Application No. PCT/CN2020/072637, filed on Jan. 17, 2020, commonly assigned to Soltrium Advanced Materials Technology, Ltd. Shenzhen with U.S. Attorney Docket No. ST0702-001200US, filed concurrently on Jun. 13, 2021, and U.S. Attorney Docket No. ST0702-001300US, filed concurrently on Jun. 13, 2021, which are incorporated by reference herein for all purposes.

### BACKGROUND OF THE INVENTION

The present disclosure relates to the technical field of semiconductor materials, and specifically relates to an acrylic conductive paste and a preparation method and application thereof.

Conductive pastes are widely used in the manufacture and assembly of electronic equipment, integrated circuits, semiconductor devices, passive components, solar cells, solar modules and/or light-emitting diodes. Because the conductive paste provides mechanical bonding and electrical conduction paths between the two surface components, the conductive paste must have good mechanical properties and low resistance electrical conductivity.

Generally, the conductive paste formula is composed of conductive particles, polymer resin, and additives. Polymer resin usually provides a mechanical bond between two components, while conductive particles usually provide the required electrical conduction path. In addition, the morphologies of conductive particles used in traditional conductive pastes are mostly spherical, spheroidal and flaky silver particles, which leads to the contact between the two conductive particles to be a point contact. For example, as shown in FIG. 1, the contact between two spherical conductive particles is a point contact.

In order to improve the conductive performance of the conductive paste, a traditional method of increasing the number or dosage of conductive particles is usually adopted. However, this method inevitably increases the production cost of the conductive paste while increasing the conductivity. Moreover, the existing conductive paste has a long curing time during use, and the adhesion of the conductive paste is poor.

Therefore, in order to solve the problems of poor conductivity, longer curing time, and poor adhesion of existing conductive pastes, it is desired to develop an improved acrylic conductive paste.

### BRIEF SUMMARY OF THE INVENTION

The present disclosure relates to the technical field of semiconductor materials, and with an objective to provide an acrylic conductive paste and a preparation method and application thereof.

In order to achieve the above objectives, the present disclosure provides an acrylic conductive paste, based on 100 parts by weight, including the following components, 30˜84 parts of conductive particles, 15˜45 parts of acrylate, 0.5˜2.5 parts of adhesion promoter and 0.5˜3.0 parts of initiator. Among them, the conductive particles include three-dimensional dendritic conductive particles; the adhesion promoter is a mixture of silane coupling agent and phosphate.

The acrylic conductive paste according to some embodiments of the present disclosure is a heat-curing conductive adhesive. It can be cured within 5 to 300 seconds at 80° C. to 170° C. during use, and the curing speed is fast. The acrylic conductive paste can also be stored for a long time under room temperature conditions of 22° C. to 25° C., for example, it can be stored for 48 hours, which indicates that the acrylic conductive paste according to some embodiments of the present disclosure can operate at room temperature for a long time. The acrylic conductive paste according to some embodiments the present disclosure is sufficient for various long-term use under a variety of electronic assembly and solar photovoltaic module production operating conditions. The acrylic conductive paste according to some embodiments of the present disclosure can also form a conductive path between two substrates or components and the substrate, and can be used in the manufacture and assembly of electronic equipment, integrated circuits, semiconductor devices, passive components, and solar photovoltaic modules.

The adhesion promoter associated with the acrylic conductive paste of the present disclosure is a mixture of silane coupling agent and phosphate ester and can set up a “molecular bridge” between the acrylic conductive paste and the interface between the semiconductor components such as chips, and connect two materials with very different properties that needs to be bonded together and increase the bond strength. In addition, the mixed use of silane coupling agent and phosphate ester has higher adhesion and better plasticity than using silane coupling agent alone.

Further, the specific surface area of the three-dimensional dendritic conductive particles is in a range of 0.2˜3.5 m²/g. In order to meet the application of the acrylic conductive paste in different scenarios, the average particle diameter or median diameter D50 of the three-dimensional dendritic conductive particles is usually in a range of 0.1 μm˜50 μm. In a specific embodiment, the specific surface area of the three-dimensional dendritic conductive particles may be 0.2 m²/g, or 3.5 m²/g, or 0.6 m²/g, etc. Because the specific surface area affects the conductivity of the conductive paste, so the specific surface area of the three-dimensional dendritic conductive particles in the acrylic conductive paste of the present disclosure is restricted in the range of 0.2˜3.5 m²/g.

In addition, the ratio of the weight of the three-dimensional dendritic conductive particles in the acrylic conductive paste of the present disclosure to the total weight of the conductive particles is one selected from (0.05˜0.95):1, that is, the ratio can be 0.05:1; it can also be 0.95:1; or is any one in between such as 0.5:1. etc.

Further, the three-dimensional dendritic conductive particles in the acrylic conductive paste of the present disclosure are three-dimensional dendritic silver particles and/or three-dimensional dendritic silver-coated copper particles. Optionally, the three-dimensional dendritic conductive particles can be three-dimensional dendritic silver particles, or three-dimensional dendritic silver-coated copper particles, or a mixture of three-dimensional dendritic silver particles and three-dimensional dendritic silver-coated copper particles.

If a conductive paste contains only three-dimensional dendritic conductive particles, it may cause the viscosity to increase, and even affect the printability of the conductive paste. Therefore, in order to ensure that under the condition of no significant change of the conductivity, the viscosity of the conductive paste is reduced with enhanced printability by including at least 5% of one or a combination of more of spherical conductive particles, flaky conductive particles, or spheroidal conductive particles in the conductive particles with three-dimensional dendritic structures.

In a specific embodiment, the conductive particles are a mixture of spherical silver particles and three-dimensional dendritic silver particles, and the ratio of the weight of the three-dimensional dendritic silver particles to the total weight of the conductive particles is one selected from (0.05˜0.95):1. The ratio of the weight of the three-dimensional dendritic silver particles to the total weight of the conductive particles can be 0.05:1; or 0.95:1; or any one in between such as 0.5:1, etc. The three-dimensional dendritic silver particles are characterized by a specific surface area in a range of 0.2˜3.5 m²/g, and the spherical silver particles are characterized by particle sizes selected from 0.1 μm˜50 μm. The size of the spherical silver particles can be selected from a range between 0.1 and 50 μm according to actual needs. For example, it can be 0.1 μm, or 30 μm, or 50 μm, etc.

In a specific embodiment, the conductive particles are a mixture of spherical silver particles and three-dimensional dendritic silver-coated copper particles, and the ratio of the weight of the three-dimensional dendritic silver-coated copper particles to the total weight of the conductive particles is one selected from (0.05˜0.95):1. The specific surface area of the three-dimensional dendritic silver-coated copper particles is in a range of 0.2˜3.5 m²/g, and the size of the spherical silver particles is selected from 0.1 μm˜50 μm. The ratio of the weight of the three-dimensional dendritic silver-coated copper particles to the total weight of the conductive particles can be 0.05:1; or 0.95:1; or any one in between such as 0.5:1, etc. The size of the spherical silver particles can be selected from a range between 0.1 and 50 μm according to actual needs. For example, it can be 0.1 μm, or 30 μm, or 50 μm, etc.

In a specific embodiment, the conductive particles are a mixture of flaky silver particles and three-dimensional dendritic silver particles. A weight ratio of the three-dimensional dendritic silver particles to the total weight of the conductive particles is one selected from (0.05˜0.95):1. The specific surface area of three-dimensional dendritic silver particles is limited within 0.2˜3.5 m²/g, and the size of flaky silver particles is selected from 0.1 μm˜50 μm. That is, the ratio of the weight of the three-dimensional dendritic silver particles to the total weight of the conductive particles can be 0.05:1; or 0.95:1; or any one in between such as 0.5:1, etc. The size of the flaky silver particles can be selected from a range between 0.1 and 50 μm according to actual needs, such as 0.1 μm, or 30 μm, or 50 μm, etc.

In a specific embodiment, the conductive particles are a mixture of flaky silver particles and three-dimensional dendritic silver-coated copper particles, and the ratio of the weight of the three-dimensional dendritic silver-coated copper particles to the total weight of the conductive particles is one selected from (0.05˜0.95):1. The specific surface area of the three-dimensional dendritic silver-coated copper particles is limited in a range of 0.2˜3.5 m²/g, and the size of the flaky silver particles is selected from 0.1 μm˜50 μm. Optionally, the ratio of the weight of the three-dimensional dendritic silver-coated copper particles to the total weight of the conductive particles can be 0.05:1; or 0.95:1; or any one in between such as 0.5:1, etc. The size of the flaky silver particles can be selected from a range between 0.1 and 50 μm based on actual needs, for example, 0.1 μm, or 30 μm, or 50 μm, etc.

In a specific embodiment, the conductive particles are a mixture of flaky silver-coated copper particles and three-dimensional dendritic silver-coated copper particles. The ratio of a weight of the three-dimensional dendritic silver-coated copper particles to the total weight of the conductive particles is one selected from (0.05˜0.95):1. The specific surface area of the three-dimensional dendritic silver-coated copper particles is limited in a range of 0.2˜3.5 m²/g, and the size of the flaky silver-coated copper particles is selected from 0.1 μm˜50 μm. That is, the ratio of the weight of the three-dimensional dendritic silver-coated copper particles to the total weight of the conductive particles can be 0.05:1; or 0.95:1; or any one in between such as 0.5:1, etc. The size of the flaky silver-coated copper particles can be selected from a range between 0.1 and 50 μm based on actual needs. For example, it can be 0.1 μm, it can be 50 μm, it can also be 30 μm, etc.

In a specific embodiment, the conductive particles are a mixture of spherical silver-coated copper particles and three-dimensional dendritic silver-coated copper particles, and the ratio of the weight of the three-dimensional dendritic silver-coated copper particles to the total weight of the conductive particles is one selected from (0.05˜0.95):1. The specific surface area of the three-dimensional dendritic silver-coated copper particles is limited in a range of 0.2˜3.5 m²/g, and the size of the spherical silver-coated copper particles is selected from a range of 0.1 tm˜50 μm. That is, the ratio of the weight of three-dimensional dendritic silver-coated copper particles to the total weight of conductive particles can be 0.05:1; it can also be 0.95:1; it can also be 0.5:1, etc. The size of spherical silver-coated copper particles can be selected from a range between 0.1 and 50 μm based on actual needs, such as 0.1 μm, or 50 μm, or 30 μm, etc.

Further, in a specific embodiment, the conductive particles are a mixture of three-dimensional dendritic silver particles and three-dimensional dendritic silver-coated copper particles, and the ratio of the weight of the three-dimensional dendritic silver-coated copper particles to the total weight of the conductive particles is one selected from (0.05˜0.95):1. The specific surface area of the three-dimensional dendritic silver particles is limited in a range of 0.2˜3.5 m²/g, and the specific surface area of the three-dimensional dendritic silver-coated copper particles is limited in a range of 0.2˜3.5 m²/g. That is, the ratio of the weight of the three-dimensional dendritic silver-coated copper particles to the total weight of the conductive particles can be 0.05:1; it can also be 0.95:1; or it can also be any one between 0.05:1 and 0.95:1 such as 0.5:1, etc. The specific surface area of the three-dimensional dendritic silver particles can be 0.2 m²/g, 3.5 m²/g, or any one in between such as 2.0 m²/g, etc.

Further, in some embodiments, the particle size of the three-dimensional dendritic silver particles in the acrylic conductive paste of the present disclosure is selected from a range of 0.2 μm˜50 μm.

Further, in some embodiments, the particle size of the three-dimensional dendritic silver-coated copper particles in the acrylic conductive paste of the present disclosure is selected from a range of 0.2 μm˜50 μm.

Further, the acrylate component in the acrylic conductive paste of the present disclosure is a mixture of acrylate monomers and acrylate oligomers. Optionally, the ratio of the weight of acrylate monomers to the total weight of acrylate is one selected from (0.1 to 0.9):1. Because the acrylate is cured to form an acrylic resin, and the acrylic resin has good mechanical properties and weather resistance, and exhibits excellent performance in a high temperature and high humidity environment, so it can interact with semiconductor components and substrates. The acrylic conductive paste of the present disclosure demonstrates good adhesion and improvement in weather resistance.

In addition, it is also noted that the ratio of the weight of the acrylate monomers of the present disclosure to the total weight of the acrylate can be 0.1:1; or 0.9:1; or any one in between such as 0.625:1, etc.

Further, the acrylate monomers in the acrylic conductive paste of the present disclosure are one or more of isobornyl acrylate, isobornyl methacrylate, ethoxyethoxyethyl acrylate, lauric acid acrylate, tetrahydrofurfuryl acrylate, or 2-phenoxy ethyl acrylate. In the specific embodiment, the acrylate monomers can be any one kind of the above-mentioned multiple kinds of monomers, or it can be any two or a combination of two or more of the above-mentioned monomers.

Acrylate oligomers in the acrylic conductive paste of the present disclosure are one or more of polyester acrylate and aliphatic polyurethane acrylic oligomers. In some embodiments, the acrylate oligomers can be polyester acrylate, or any aliphatic polyurethane acrylic oligomers. Or, the acrylate oligomers include polyester acrylate or any one or more aliphatic polyurethane acrylic oligomers.

For example, the aliphatic urethane acrylic oligomers used in the specific embodiments can be the aliphatic urethane acrylic oligomers with the brand name CN8881NS purchased from Sartomer (Guangzhou) Chemical Co., Ltd., or aliphatic polyurethane acrylic oligomers with the brand number CN9014NS purchased from Sartomer (Guangzhou) Chemical Co., Ltd.

Furthermore, in the adhesion promoter of the acrylic conductive paste, the ratio of the weight of the phosphate to the total weight of the adhesion promoter is selected from (0.1˜0.5):1; indicating the weight of the phosphate and the total weight of the adhesion promoter can be 0.1:1; or 0.5:1; or any one in between such as 0.3:1, etc. The role of the adhesion promoter is to further increase the adhesion between the conductive paste and the bonding substrate.

Furthermore, the alkane coupling agent in the acrylic conductive paste of the present disclosure is one or a combination of more of 3-methacryloxypropyldimethoxysilane, 3-methacryloxypropyltrimethoxysilane, 3-methacryloxypropyldimethoxysilane, and 3-methacryloxypropyldimethoxysilane. Ethoxysilane, 3-methacryloxypropyltriethoxysilane, vinyltrimethoxysilane, vinyltriethoxysilane, styrene trimethoxysilane, or 3-methacryloxypropyltriethoxysilane. Phosphate is one or a combination of more of 2-hydroxyethyl methacrylate phosphate, trifunctional acrylate phosphate, alkyl acrylate phosphate, or trifunctional acrylate phosphate.

Furthermore, the initiator in the acrylic conductive paste of the present disclosure is one of a combination of more of tert-butyl peroxide neodecanoate, tert-butyl peroxide 2-ethylhexyl acid, 1,1′-bis(tert-butylperoxy)-3,3,5-trimethyl ring hexane or 1,1′-bis(tert-amylperoxy)cyclohexane. That is, in the specific embodiment, the initiator can be selected from one or more of the above listed initiators according to actual needs. The purpose of the initiator is to initiate a curing reaction of the conductive paste during its application.

Optionally, the conductive particles in the acrylic conductive paste of the present disclosure include one or a combination of two of silver particles or silver-coated copper particles.

Optionally, the conductive particles in the acrylic conductive paste of the present disclosure include one or a combination of more of three-dimensional dendritic silver particles, spherical silver particles, flaky silver particles or spheroidal silver particles.

Optionally, the conductive particles in the acrylic conductive paste of the present disclosure include one or a combination of more of three-dimensional dendritic silver particles, spherical silver-coated copper particles, flaky silver-coated copper particles, or spheroidal silver-coated copper particles.

Optionally, the conductive particles in the acrylic conductive paste of the present disclosure include one of a combination of more of three-dimensional dendritic silver-coated copper particles, spherical silver-coated copper particles, flaky silver-coated copper particles, or spheroidal silver-coated copper particles.

Optionally, the conductive particles in the acrylic conductive paste of the present disclosure include one or a combination of more of three-dimensional dendritic silver-coated copper particles, spherical silver particles, flaky silver particles, or spheroidal silver particles.

Optionally, the conductive particles in the acrylic conductive paste of the present disclosure include one or a combination of more of three-dimensional dendritic silver-coated copper particles, three-dimensional dendritic silver particles, and spherical silver-coated copper particles, flaky silver-coated copper particles, spheroidal silver-coated copper particles, spherical silver particles, and flaky silver particles or spherical silver particles.

In another aspect, the present disclosure also provides a method for preparing the acrylic conductive paste described herein. The method includes the following steps:

S1, based on 100 parts of total weight, weighing 30˜84 parts of conductive particles, 15˜45 parts of acrylate, 0.5˜2.5 parts of adhesion promoter and 0.5˜3.0 parts of initiator; wherein, the conductive particles include three-dimensional dendritic conductive particles, and the adhesion promoter is a mixture of a silane coupling agent and a phosphate ester. It is noted that weighing raw materials may have about 10% error margin.

S2, disposing the acrylate, the adhesion promoter, and the initiator according to weighted parts above in a reactor and stirring evenly, then adding the conductive particles of the weighted parts and stirring evenly to obtain a mixture.

S3, grinding the mixture to obtaining the acrylic conductive paste described herein.

In yet another aspect, the present disclosure also provides an application method of the above-mentioned acrylic conductive paste to semiconductor components for packaging a semiconductor device. In a specific application, using the acrylic conductive paste of the present disclosure includes printing the acrylic conductive paste on a substrate of the semiconductor component, and disposing the substrate printed with the acrylic conductive paste in an environment of 80° C. to 170° C. (for example, 150° C.), to cure for 5-300 s (for example, 15 s) to obtain a semiconductor component applied with the acrylic conductive paste of the present disclosure. The application method further includes packaging the semiconductor component into a semiconductor device.

Compared with the prior art, the acrylic conductive paste according to some embodiments of the present disclosure used in the above application scheme provides several beneficial effects. The acrylic conductive paste in the present disclosure uses three-dimensional dendritic conductive particles to cause multi-point contacts formed between the two conductive particles so that contact resistance is greatly reduced. Because the conductive performance is greatly improved, the use of conductive particles can be reduced, which reduces costs and improve performance of the semiconductor device adopting this acrylic conductive paste.

The acrylic conductive paste according to some embodiments of the present disclosure uses acrylic ester and a mixture of silane coupling agent and phosphate ester as adhesion promoters, so that the acrylic conductive paste has characteristics of fast curing speed, strong adhesion, and long-time room temperature operability.

Compared with the prior art, the preparation method of the acrylic conductive paste of the present disclosure further includes beneficial effects of simple to process and easy to operate, and convenient for industrial production.

### BRIEF DESCRIPTION OF THE DRAWINGS

FIG. 1 is a schematic diagram of the contact between two spherical conductive particles in an existing conductive paste; wherein 001 represents the spherical conductive particle, and 0011a represents the contact point between the two spherical conductive particles.

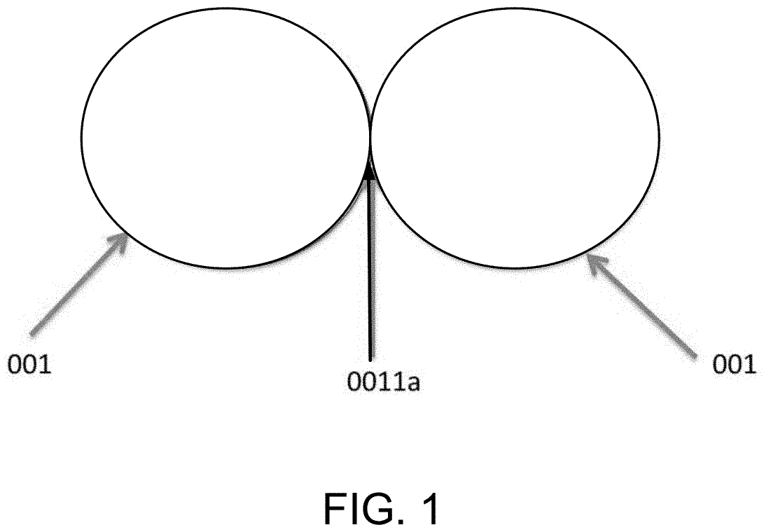

FIG. 2 is a scanning electron microscope (SEM) image of three-dimensional dendritic silver particles in an acrylic conductive paste provided in the present disclosure.

FIG. 3 is another SEM image of three-dimensional dendritic silver particles in an acrylic conductive paste provided in the present disclosure.

FIG. 4 is a schematic diagram of the contact between three-dimensional dendritic conductive particles and spherical conductive particles in an acrylic conductive paste provided in the present disclosure; among them, 002 represents three-dimensional dendritic conductive particles, 001 represents spherical conductive particles; 0012a is the contact point.

FIG. 5 is a schematic diagram of the contact between the three-dimensional dendritic conductive particles and the three-dimensional dendritic conductive particles in an acrylic conductive paste provided in the present disclosure; among them, 002a and 002b represent the three-dimensional dendritic conductive particles, and 002ab represents the contact point.

FIG. 6 is a schematic diagram of bond strength test for the acrylic conductive paste provided in the present disclosure.

### DETAILED DESCRIPTION OF THE INVENTION

To make the technical problem to be solved, the technical solution, and the beneficial effects of the present disclosure clearer, the present disclosure is further described in detail with reference to examples and accompanying drawings. It is noted that the specific examples described herein are merely provided for illustrating, instead of limiting the present disclosure.

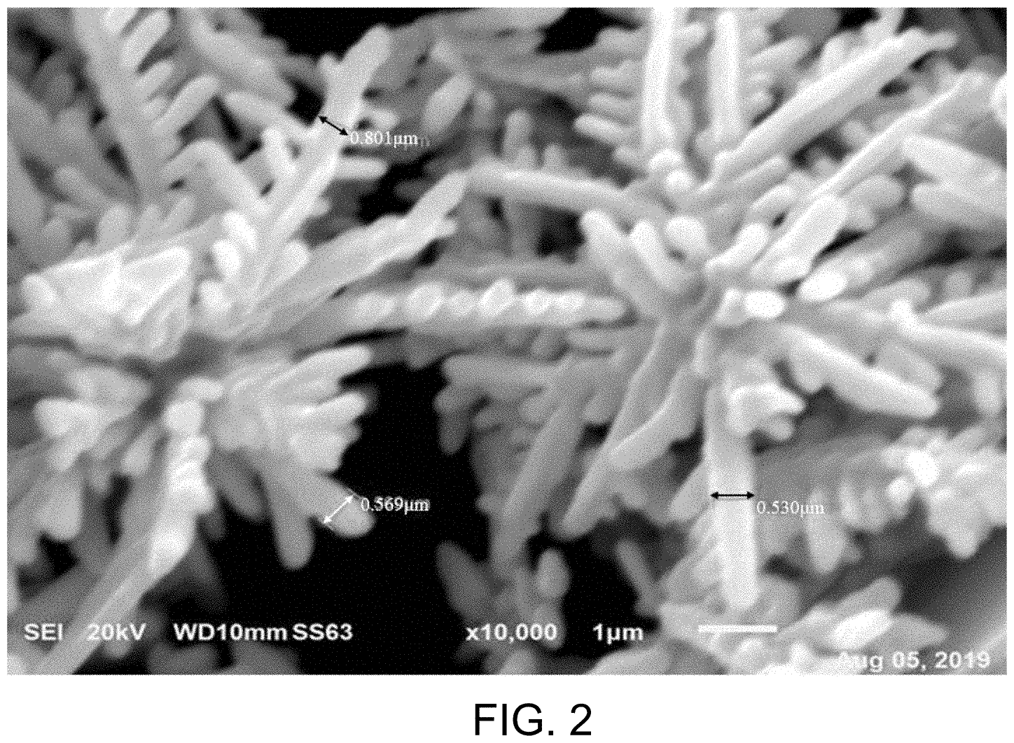

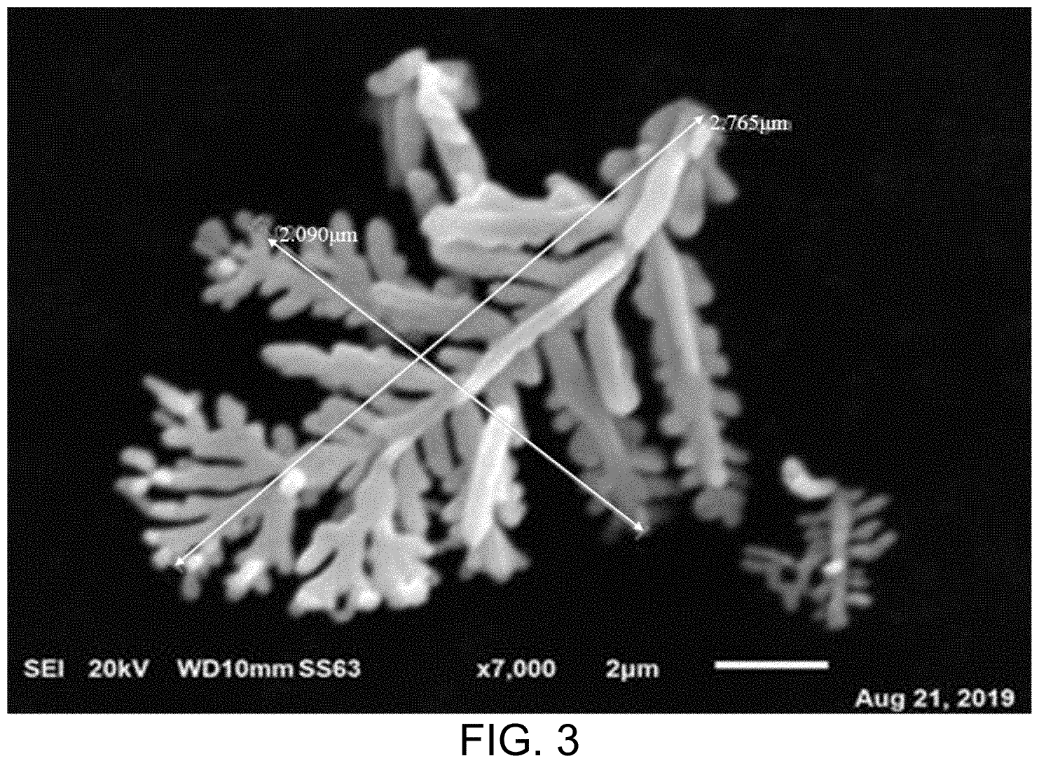

In an aspect, the present disclosure provides an improved acrylic conductive paste with increased electrical conductivity, short curing time, and strong adhesion for application with semiconductor components. In some embodiments, the acrylic conductive paste includes ascertain amount of three-dimensional dendritic conductive particles in total conductive particles to greatly improve contacts between the conductive particles to enhance electrical conductivity yet without pushing up viscosity. In some embodiments, three-dimensional dendritic silver particles and three-dimensional dendritic silver-coated copper particles used in the acrylic conductive paste can be obtained through purchase from commercial sources. Sample images of the three-dimensional dendritic silver particles obtained from the purchase were taken by scanning electron microscope (SEM) as shown in FIG. 2 and FIG. 3. The rest conductive particles used together with the three-dimensional dendritic conductive particles in the following examples include spherical silver particles, flaky silver particles, spheroidal silver particles, spherical silver-coated copper particles, flaky silver-coated copper particles, and spheroidal silver-coated copper particles.

### Embodiment 1

An acrylic conductive paste is provided according to the embodiment of the present disclosure, based on a total weight of 100 parts, including the following components: 20 parts of spherical silver particles; 50 parts of three-dimensional dendritic silver particles; 17.5 parts of acrylate monomers; 10.5 parts of acrylate oligomers; 1.0 part of adhesion promoter; 1.0 part of initiator.

Specifically for this embodiment, the ratio of the weight of three-dimensional dendritic silver particles to the total weight of conductive particles is 0.71:1; the ratio of the weight of acrylate monomers to the total weight of acrylate are 0.625:1; and the ratio of the weight of phosphate to the adhesion promoter the total weight is 0.3:1.

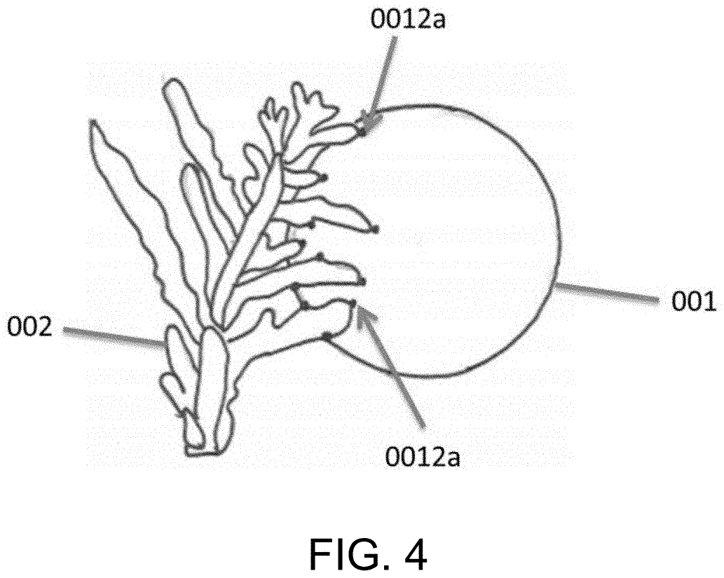

Referring to FIG. 4, the contact between the three-dimensional dendritic silver particles and spherical silver particles belong to a kind of multi-point contact. Among them, the spherical silver particles in this embodiment have a median particle diameter D50 of 1.5 μm and a specific surface area of 0.36 m²/g; the three-dimensional dendritic silver particles have a D50 of 4 μm and a specific surface area of 0.69 m²/g.

In the embodiment, the acrylate monomers in the acrylic conductive paste are isobornyl acrylate, the acrylate oligomers are polyester acrylate which can be purchased, for example, from Sartomer (Guangzhou) Chemical Co., Ltd.

In the embodiment, the adhesion promoter in the acrylic conductive paste is a mixture of silane coupling agent and phosphate. The silane coupling agent is 3-methacryloxypropyl trimethoxysilane, and the phosphate is 2-hydroxyethyl methacrylate phosphate. The initiator in the acrylic conductive paste is tert-butyl peroxide neodecanoate.

In another aspect, the present disclosure provides a method for preparing the acrylic conductive paste of this embodiment. The method includes the following steps:

S1, based on 100 parts of total weight, weighing 20 parts of spherical silver particles, 50 parts of three-dimensional dendritic silver particles, 17.5 parts of acrylate monomers, 10.5 parts of acrylate oligomers, 1.0 part of adhesion promoter, 1.0 part of initiator;

S2, disposing the acrylate, the adhesion promoter and the initiator in a stainless steel container and stirring evenly, then adding the conductive particles into the container and stirring evenly to obtain a mixture;

S3, disposing the mixture on a three-roll mill for grinding the mixture to obtain 200 g of acrylic conductive paste.

In order to test the performance of the acrylic conductive paste of the embodiment, the following tests were carried out.

### (1) Curing Time Test

In order to study the curing time of the acrylic conductive paste of this embodiment in use, the following tests are done: Take 3 clean glass sheets, label them No. 1, No. 2 and No. 3 respectively; print the acrylic conductive paste of the embodiment on the No. 1, No. 2 and No. 3 glass sheets into strips of film, and then respectively place them in an oven for curing at in 80° C., 150° C. and 170° C., and record the time.

The results show that: No. 1 glass sheet placed in an oven at 80° C., cured in 292 s; No. 2 glass sheet placed at 150° C., cured in 15 s; No. 3 glass sheet placed at 170° C., cured in 5 s. This shows that the acrylic conductive paste of this embodiment has a shorter curing time at high temperatures.

### (2) Volume Resistivity Test

In order to detect the volume resistivity of the acrylic conductive paste of this embodiment, the conductive paste in a form of strip film printed on the glass sheet No. 2 is measured on its length, width, and thickness. The volume resistivity of the acrylic conductive paste is calculated according to formula (1) below,

$$ρ = R \times \frac{b \times d}{L} \qquad ( 1 )$$

where, L, b and d are the length, width and thickness (cm) of the acrylic conductive paste sample respectively; R is the resistance of the conductive paste sample (Ω); ρ is the volume resistivity of the conductive paste sample (Ω·cm). The volume resistivity of the acrylic conductive paste is shown in Table 3.

### (3) Bonding Strength Test

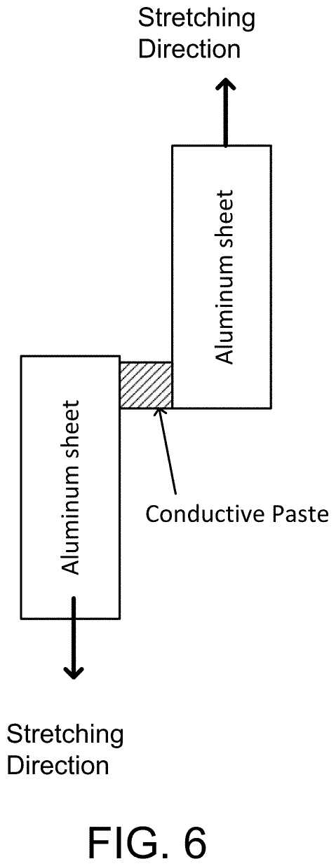

In order to test the bonding strength of the acrylic conductive paste after curing, refer to the national standard GB/T 7124-2008 Method for Measuring the Tensile Shear Strength of Adhesives (as shown in FIG. 6) to determine the bonding strength of the conductive paste of this embodiment. FIG. 6 is a schematic diagram of the test. During the measurement, a tensile machine stretches two aluminum sheets at a speed of 200 mm/min in a direction of 180° until the conductive paste film is broken. The shear strength (W) is calculated according to formula (2):

W=P/S (2)

where W is the shear strength; P is the breaking load; S is the overlap area. There are 5 tensile samples in this test. The average value of the shear strength is taken and summarized in Table 3.

### Embodiment 2

The acrylic conductive paste according to this embodiment includes, based on a total weight of 100 parts, the following components: 20 parts of flaky silver particles; 50 parts of three-dimensional dendritic silver particles; 17.5 parts of acrylate monomers; 10.5 parts of acrylate oligomers; 1.0 part of adhesion promoter; 1.0 part of initiator.

In this embodiment, the ratio of the weight of the three-dimensional dendritic silver particles to the total weight of the conductive particles is 0.71:1; the ratio of the weight of the acrylate monomers to the total weight of the acrylate are 0.625:1; the ratio of the weight of the phosphate to the total weight of the adhesion promoter is 0.3:1.

In the embodiment, the D50 of the flaky silver particles is 1.5 μm, and the specific surface area of the flaky silver particles is 0.41 m²/g. The D50 of the three-dimensional dendritic silver particles is 4 μm, and the specific surface area of the three-dimensional dendritic silver particles is 0.69 m²/g.

In the embodiment, the acrylate monomers are isobornyl acrylate, the acrylate oligomers are polyester acrylate which can be purchased, for example, from Sartomer (Guangzhou) Chemical Co., Ltd.

In the embodiment, the adhesion promoter in the acrylic conductive paste is a mixture of silane coupling agent and phosphate. The silane coupling agent is 3-methacryloxypropyltrimethoxysilane, and the phosphate is 2-hydroxyethyl methacrylate phosphate. The initiator in the acrylic conductive paste is tert-butyl peroxyneodecanoate.

The preparation method of the acrylic conductive paste of this embodiment is the same as the preparation method of Embodiment 1.

The acrylic conductive paste of the embodiment is also tested for curing time, volume resistivity and bonding strength. All test methods are the same as those of Embodiment 1. The results are also summarized in Table 3.

### Embodiment 3

This embodiment provides an acrylic conductive paste, based on a total weight of 100 parts, including the following components: 20 parts of spherical silver particles; 50 parts of three-dimensional dendritic silver-coated copper particles; 17.5 parts of acrylate monomers; acrylate oligomers 10.5 parts; 1.0 part of adhesion promoter; 1.0 part of initiator.

In the embodiment, the ratio of the weight of the three-dimensional dendritic silver-coated copper particles to the total weight of the conductive particles is 0.71:1; the ratio of the weight of the acrylate monomers to the total weight of the acrylate is 0.625:1; the ratio of the weight of the phosphate to the total weight of the adhesion promoter is 0.3:1.

FIG. 4 shows that the contact between the three-dimensional dendritic silver-coated copper particles and the spherical silver particles belongs to multi-point contact.

The D50 of the flaky silver particles in this embodiment is 1.5 μm, and the specific surface area of the flaky silver particles is 0.32 m²/g. The D50 of the three-dimensional dendritic silver-coated copper particles is 4.5 and the specific surface area of the three-dimensional dendritic silver-coated copper particles is 0.59 m²/g.

The acrylate monomers are isobornyl acrylate, the acrylate oligomers are polyester acrylate, which can be purchased, for example, from Sartomer (Guangzhou) Chemical Co., Ltd.

In the embodiment, the adhesion promoter in the acrylic conductive paste is a mixture of silane coupling agent and phosphate. The silane coupling agent is 3-methacryloxypropyltrimethoxysilane, and the phosphate is 2-hydroxyethyl methacrylate phosphate. The initiator is tert-butyl peroxyneodecanoate.

The preparation method of the acrylic conductive paste of this embodiment is the same as the preparation method of Embodiment 1.

The curing time test, volume resistivity test and bonding strength test were also performed on the conductive paste of this embodiment. All test methods are the same as those in Embodiment 1, and the results are summarized in Table 3.

### Embodiment 4

This embodiment provides an acrylic conductive paste, based on a total weight of 100 parts, including the following components: 20 parts of flaky silver particles; 50 parts of three-dimensional dendritic silver-coated copper particles; 17.5 parts of acrylate monomers; 10.5 parts of acrylate oligomers; 1.0 part of adhesion promoter; 1.0 part of initiator.

In the embodiment, the ratio of the weight of the three-dimensional dendritic silver-coated copper particles to the total weight of the conductive particles is 0.71:1; the ratio of the weight of the acrylate monomers to the total weight of the acrylate is 0.625:1; the ratio of the weight of the phosphate to the total weight of the adhesion promoter is 0.3:1.

In the embodiment, the D50 of the flaky silver particles in this embodiment is 1.5 μm, and the specific surface area of the flaky silver particles is 0.36 m²/g. The D50 of the three-dimensional dendritic silver-coated copper particles is 4.5 μm, and the specific surface area of the three-dimensional dendritic silver-coated copper particles is 0.59 m²/g.

In the embodiment, the acrylate monomers are isobornyl acrylate, the acrylate oligomers are polyester acrylate, which can be purchased, for example, from Sartomer (Guangzhou) Chemical Co., Ltd.

In the embodiment, the adhesion promoter in the acrylic conductive paste is a mixture of silane coupling agent and phosphate. The silane coupling agent is 3-methacryloxypropyltrimethoxysilane, and the phosphate is 2-hydroxyethyl methacrylate phosphate. The initiator of the conductive paste is tert-butyl peroxyneodecanoate.

The preparation method of the acrylic conductive paste of this embodiment is the same as the preparation method of Embodiment 1.

The curing time test, volume resistivity test and bonding strength test were also performed on the acrylic conductive paste of this embodiment. All specific test methods are the same as those in Embodiment 1, and the results obtained are summarized in Table 3.

### Embodiment 5

This embodiment provides an acrylic conductive paste, based on a total weight of 100 parts, including the following components: 70 parts of three-dimensional dendritic silver particles; 17.5 parts of acrylate monomers; 10.5 parts of acrylate oligomers; 1.0 Part of adhesion promoter; 1.0 part of initiator.

In the embodiment, the ratio of the weight of three-dimensional dendritic silver particles to the total weight of conductive particles is 1:1; the ratio of the weight of acrylate monomers to the total weight of acrylate is 0.625:1; the ratio of the weight of phosphate to the total weight of the adhesion promoter is 0.3:1.

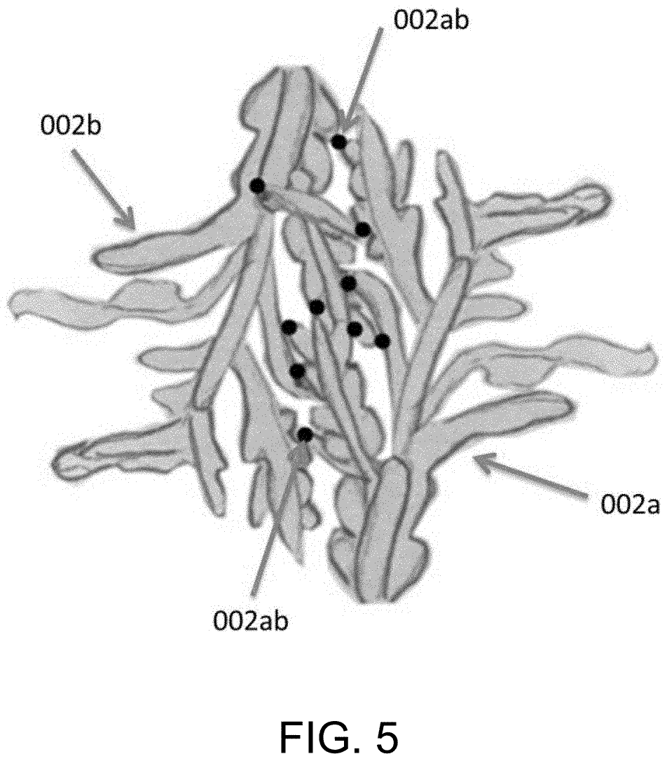

The contact formed between three-dimensional dendritic silver particles and three-dimensional dendritic silver particles is shown in FIG. 5, belonging to multi-point contact. The D50 of the three-dimensional dendritic silver particles is 4 μm, and the specific surface area of the three-dimensional dendritic silver particles is 0.69 m²/g.

In the embodiment, the acrylate monomers are isobornyl acrylate, the acrylate oligomers are polyester acrylate, which can be purchased, for example, from Sartomer (Guangzhou) Chemical Co., Ltd.

In the embodiment, the adhesion promoter in the acrylic conductive paste is a mixture of silane coupling agent and phosphate. The silane coupling agent is 3-methacryloxypropyltrimethoxysilane, and the phosphate is 2-hydroxyethyl methacrylate phosphate. The initiator is tert-butyl peroxyneodecanoate.

The preparation method of the acrylic conductive paste of this embodiment is the same as the preparation method of Embodiment 1.

The curing time test, volume resistivity test and bonding strength test were also performed on the acrylic conductive paste of this embodiment. All specific test methods are the same as those in Embodiment 1, and the results obtained are summarized in Table 3.

### Embodiment 6

This embodiment provides an acrylic conductive paste, based on a total weight of 100 parts, including the following components: 70 parts of three-dimensional dendritic silver-coated copper particles; 17.5 parts of acrylate monomers; 10.5 parts of acrylate oligomers; 1.0 part of adhesion promotor; 1.0 part of agent; 1.0 part of initiator.

In the embodiment, the ratio of the weight of the three-dimensional dendritic silver-coated copper particles to the total weight of the conductive particles is 1:1; the ratio of the weight of the acrylate monomers to the total weight of the acrylate is 0.625:1; the ratio of the weight of the phosphate to the total weight of the adhesion promotor is 0.3:1.

In the embodiment, the D50 of the three-dimensional dendritic silver-coated copper particles is 4.5 μm, and the specific surface area of the three-dimensional dendritic silver-coated copper particles is 0.59 m²/g.

The acrylate monomers are isobornyl acrylate, the acrylate oligomers are polyester acrylate, which can be purchased, for example, from Sartomer (Guangzhou) Chemical Co., Ltd.

In the embodiment, the adhesion promoter in the acrylic conductive paste is a mixture of agent and phosphate. The agent is silane coupling agent. The silane coupling agent is 3-methacryloxypropyltrimethoxysilane, and the phosphate is 2-hydroxyethyl methacrylate phosphate. The initiator is tert-butyl peroxyneodecanoate.

The preparation method of the acrylic conductive paste of this embodiment is the same as the preparation method of Embodiment 1.

The curing time test, volume resistivity test and bonding strength test were also performed on the acrylic conductive paste of this embodiment. All specific test methods are the same as those in Embodiment 1, and the results obtained are summarized in Table 3.

### Embodiment 7

This embodiment provides an acrylic conductive paste, based on 100 parts by total weight, including the following components: 60 parts of three-dimensional dendritic silver particles; 22.5 parts of acrylate monomers; 15.5 parts of acrylate oligomers; 1.0 part of adhesion promoter; 1.0 part of initiator.

In the embodiment, the ratio of the weight of the three-dimensional dendritic silver particles to the total weight of the conductive particles is 1:1; the ratio of the weight of the acrylate monomers to the total weight of the acrylate is 0.592:1; the ratio of the weight of the phosphate to the total weight of the adhesion promoter is 0.3:1.

In the embodiment, the D50 of the three-dimensional dendritic silver particles is 4 μm, and the specific surface area of the three-dimensional dendritic silver particles is 0.69 m²/g.

The acrylate monomers are isobornyl acrylate, the acrylate oligomers are polyester acrylate, which can be purchased, for example, from Sartomer (Guangzhou) Chemical Co., Ltd.

In the embodiment, the adhesion promoter in the acrylic conductive paste is a mixture of silane coupling agent and phosphate. The silane coupling agent is 3-methacryloxypropyltrimethoxysilane, and the phosphate is 2-hydroxyethyl methacrylate phosphate; among them, the initiator is tert-butyl peroxyneodecanoate.

The preparation method of the acrylic conductive paste of this embodiment is the same as the preparation method of Embodiment 1.

The curing time test, volume resistivity test and bonding strength test were also performed on the acrylic conductive paste of this embodiment. All specific test methods are the same as those in Embodiment 1, and the results obtained are summarized in Table 3.

### Embodiment 8

This embodiment provides an acrylic conductive paste, based on a total weight of 100 parts, including the following components: 70 parts of three-dimensional dendritic silver particles; 17.5 parts of acrylate monomers; 10.5 parts of acrylate oligomers; 1.0 part of adhesion promoter; 1.0 part of initiator.

In the embodiment, the ratio of the weight of three-dimensional dendritic silver particles to the total weight of conductive particles is 1:1; the ratio of the weight of acrylate monomers to the total weight of acrylate is 0.625:1; the ratio of the weight of phosphate to the total weight of the adhesion promoter is 0.3:1.

In the embodiment, The D50 of the three-dimensional dendritic silver particles is 2 μm, and the specific surface area of the three-dimensional dendritic silver particles is 3.5 m²/g.

The acrylate monomers are isobornyl acrylate, the acrylate oligomers are polyester acrylate, which can be purchased, for example, from Sartomer (Guangzhou) Chemical Co., Ltd.

In the embodiment, the adhesion promoter in the acrylic conductive paste is a mixture of silane coupling agent and phosphate. The silane coupling agent is 3-methacryloxypropyltrimethoxysilane, and the phosphate is 2-hydroxyethyl methacrylate phosphate; among them, the initiator is tert-butyl peroxyneodecanoate.

The preparation method of the acrylic conductive paste of this embodiment is the same as the preparation method of Embodiment 1.

The curing time test, volume resistivity test and bonding strength test were also performed on the acrylic conductive paste of this embodiment. All specific test methods are the same as those in Embodiment 1, and the results obtained are summarized in Table 3.

The contents and parameters of each component of the acrylic conductive paste of the above Embodiments 1 to 8 are shown in Table 1.

TABLE 1
The content and parameters of each component of the acrylic conductive paste of Embodiment 1 to Embodiment 8

| | | | Acrylate | | Adhesion promotor | | |
|---|---|---|---|---|---|---|---|
| | Conductive particles | | Acrylate | Acrylate | Silane | | |
| Embodiment | Spherical/flaky | Dendritic | monomers | oligomers | coupling agent | phosphate | Initiator |
| 1 | Spherical | Dendritic silver | 17.5 parts | 10.5 parts | 0.7 parts | 0.3 parts | 1 part |
| | silver particles | particles | (Isobornyl | (Polyester | | | |
| | 20 parts | 50 parts | acrylate) | acrylate) | | | |
| | | Specific surface | | | | | |
| | | area 0.69 m²/g | | | | | |
| 2 | Flaky silver | Dendritic silver | 17.5 parts | 10.5 parts | 0.7 parts | 0.3 parts | 1 part |
| | particles | particles | (Isobornyl | (Polyester | | | |
| | 20 parts | 50 parts | acrylate) | acrylate) | | | |
| | | Specific surface | | | | | |
| | | area 0.69 m²/g | | | | | |
| 3 | Spherical | Dendritic silver- | 17.5 parts | 10.5 parts | 0.7 parts | 0.3 parts | 1 part |
| | silver particles | coated copper | (Isobornyl | (Polyester | | | |
| | 20 parts | particles | acrylate) | acrylate) | | | |
| | | 50 parts | | | | | |
| | | Specific surface | | | | | |
| | | area 0.59 m²/g | | | | | |
| 4 | Flaky silver | Dendritic silver- | 17.5 parts | 10.5 parts | 0.7 parts | 0.3 parts | 1 part |
| | particles | coated copper | (Isobornyl | (Polyester | | | |
| | 20 parts | particles | acrylate) | acrylate) | | | |
| | | 50 parts | | | | | |
| | | Specific surface | | | | | |
| | | area 0.59 m²/g | | | | | |
| 5 | None | Dendritic silver | 17.5 parts | 10.5 parts | 0.7 parts | 0.3 parts | 1 part |
| | | particles | (Isobornyl | (Polyester | | | |
| | | 70 parts | acrylate) | acrylate) | | | |
| | | Specific surface | | | | | |
| | | area 0.69 m²/g | | | | | |
| 6 | None | Dendritic silver- | 17.5 parts | 10.5 parts | 0.7 parts | 0.3 parts | 1 part |
| | | coated copper | (Isobornyl | (Polyester | | | |
| | | particles | acrylate) | acrylate) | | | |
| | | 50 parts | | | | | |
| | | Specific surface | | | | | |
| | | area 0.59 m²/g | | | | | |
| 7 | None | Dendritic silver | 22.5 parts | 15.5 parts | 0.7 parts | 0.3 parts | 1 part |
| | | particles | (Isobornyl | (Polyester | | | |
| | | 60 parts | acrylate) | acrylate) | | | |
| | | Specific surface | | | | | |
| | | area 0.69 m²/g | | | | | |
| 8 | None | Dendritic silver | 17.5 parts | 10.5 parts | 0.7 parts | 0.3 parts | 1 part |
| | | particles | (Isobornyl | (Polyester | | | |
| | | 70 parts | acrylate) | acrylate) | | | |
| | | Specific surface | | | | | |
| | | area 3.5 m²/g | | | | | |

### Comparative Example 1

A conductive paste used in this comparative example includes, based on a total weight of 100 parts, the following components: 70 parts of spherical silver particles; 17.5 parts of acrylate monomers; 10.5 parts of acrylate oligomers; 1.0 part of adhesion promoter; 1.0 part of initiator.

In the example, the conductive paste of this comparative example does not contain conductive particles with three-dimensional dendritic microstructures. The ratio of the weight of the acrylate monomers to the total weight of the acrylate is still 0.625:1. The ratio of the weight of the phosphate to the total weight of the adhesion promoter is still 0.3:1. The median diameter D50 of spherical silver particles is 1.5 μm, and the specific surface area of the spherical silver particles is 0.36 m²/g. The acrylate monomers are isobornyl acrylate, the acrylate oligomers are polyester acrylate. The adhesion promoter in the acrylic conductive paste is a mixture of silane coupling agent and phosphate. The silane coupling agent is 3-methacryloxypropyltrimethoxysilane, and the phosphate is 2-hydroxyethyl methacrylate phosphate. The initiator is tert-butyl peroxyneodecanoate.

The preparation method of the conductive paste of this comparative example is the same as the preparation method of Embodiment 1.

Similarly, the conductive paste of this comparative example was tested for curing time, volume resistivity test and bonding strength. The specific test method is the same as that of Embodiment 1, and the results obtained are also summarized in Table 3.

### Comparative Example 2

This comparative example provides a conductive paste, based on a total weight of 100 parts, including the following components: 70 parts of flaky silver particles; 17.5 parts of acrylate monomers; 10.5 parts of acrylate oligomers; 1.0 part of adhesion promoter; 1.0 part of initiator.

In this example, the conductive paste of this comparative example does not contain conductive particles with three-dimensional dendritic microstructures, and the ratio of the weight of the acrylate monomers to the total weight of the acrylate is still 0.625:1; the ratio of the weight of the phosphate to the total weight of the adhesion promoter is still 0.3:1. The D50 of flaky silver particles is 1.5 μm, and the specific surface area of the flaky silver particles is 0.41 m²/g.

The acrylate monomers are isobornyl acrylate, the acrylate oligomers are polyester acrylate. The adhesion promoter in the conductive paste is a mixture of silane coupling agent and phosphate. The silane coupling agent is 3-methacryloxypropyltrimethoxysilane, and the phosphate is 2-hydroxyethyl methacrylate phosphate. The initiator is tert-butyl peroxyneodecanoate.

The preparation method of the conductive paste of this comparative example is the same as the preparation method of Embodiment 1.

Similarly, the conductive paste of this comparative example was tested for curing time, volume resistivity test and bonding strength. The specific test method is the same as that of Embodiment 1, and the results obtained are also summarized in Table 3.

### Comparative Example 3

This comparative example provides a conductive paste, based on a total weight of 100 parts, including the following components: 70 parts of three-dimensional dendritic silver particles; 17.5 parts of acrylate monomers; 10.5 parts of acrylate oligomers; 1.0 part of adhesion promoter; 1.0 part of initiator.

In this example, the ratio of the weight of three-dimensional dendritic silver particles to the total weight of conductive particles is 1:1; the ratio of the weight of acrylate monomers to the total weight of acrylate is 0.625:1; the ratio of the weight of phosphate to the total weight of the adhesion promoter is 0.3:1. The D50 of the three-dimensional dendritic silver particles is 4 μm, and the specific surface area of the three-dimensional dendritic silver particles is 4.19 m²/g. The acrylate monomers are isobornyl acrylate, the acrylate oligomers are polyester acrylate. The adhesion promoter in the conductive paste is a mixture of silane coupling agent and phosphate. The silane coupling agent is 3-methacryloxypropyltrimethoxysilane, and the phosphate is 2-hydroxyethyl methacrylate phosphate. The initiator is tert-butyl peroxyneodecanoate.

The preparation method of the conductive paste of this comparative example is the same as the preparation method of Embodiment 1.

Similarly, the conductive paste of this comparative example was tested for curing time, volume resistivity test and bonding strength. The specific test method is the same as that of Embodiment 1, and the results obtained are also summarized in Table 3.

### Comparative Example 4

The conductive paste of this comparative example is a kind of acrylic series conductive adhesive CA3556HF widely used in the market. The conductive paste of this comparative example has also been tested for curing time, volume resistivity and bonding strength. The specific test method is the same as that in Embodiment 1, the results obtained are summarized in Table 3.

### Comparative Example 5

This comparative example provides a conductive paste, based on a total weight of 100 parts, including the following components: 20 parts of spherical silver particles; 50 parts of three-dimensional dendritic silver particles; 17.5 parts of acrylate monomers; 10.5 parts of acrylate oligomers; 1.0 part of adhesion promoter; 1.0 part of initiator.

In this example, the ratio of the weight of the three-dimensional dendritic silver particles to the total weight of the conductive particles is 0.71:1; the ratio of the weight of the acrylate monomers to the total weight of the acrylate is 0.625:1; the ratio of the weight of the phosphate to the total weight of the adhesion promoter is 0:1, indicating that the adhesion promoter of this comparative example does not contain phosphate ester.

In this example, the D50 of the spherical silver particles is 1.5 μm and the specific surface area of the spherical silver particles is 0.36 m²/g. The D50 of the three-dimensional dendritic silver particles is 4 μm and the specific surface area of the three-dimensional dendritic silver particles is 0.69 m²/g. The acrylate monomers are isobornyl acrylate, the acrylate oligomers are polyester acrylate.

In this example, the adhesion promoter in the conductive paste is a mixture of silane coupling agent and phosphate. The silane coupling agent is 3-methacryloxypropyltrimethoxysilane, and the phosphate is 2-hydroxyethyl methacrylate phosphate. The initiator is tert-butyl peroxyneodecanoate.

The preparation method of the conductive paste of this comparative example is the same as the preparation method of Embodiment 1.

Similarly, the conductive paste of this comparative example was tested for curing time, volume resistivity test and bonding strength. The specific test method is the same as that of Embodiment 1, and the results obtained are also summarized in Table 3.

The contents and parameters of each component of the acrylic conductive paste of Embodiment 1, Embodiment 5, and Comparative Example 1 to Comparative Example 5 are shown in Table 2.

TABLE 2
The content and parameters of each component of the acrylic conductive paste of Embodiment 1, Embodiment 5, and Comparative
Example 1 to Comparative Example 5.

| | | | Acrylate | | Adhesion promotor | | |
|---|---|---|---|---|---|---|---|
| | Conductive particles | | Acrylate | Acrylate | Silane | | |
| | Spherical/flaky | Dendritic | monomers | oligomers | coupling agent | Phosphate | Initiator |
| 1 | Spherical | Dendritic silver | 17.5 parts | 10.5 parts | 0.7 parts | 0.3 parts | 1 part |
| | silver particles | particles 50 parts | (Isobornyl | (Polyester | | | |
| | 20 parts | Specific surface area | acrylate) | acrylate) | | | |
| | | 0.69 m²/g | | | | | |
| 5 | None | Dendritic silver | 17.5 parts | 10.5 parts | 0.7 parts | 0.3 parts | 1 part |
| | | particles 70 parts | (Isobornyl | (Polyester | | | |
| | | Specific surface area | acrylate) | acrylate) | | | |
| | | 0.69 m²/g | | | | | |
| 1’ | Spherical | None | 17.5 parts | 10.5 parts | 0.7 parts | 0.3 parts | 1 part |
| | silver particles | | (Isobornyl | (Polyester | | | |
| | 70 parts | | acrylate) | acrylate) | | | |
| 2’ | Flaky silver | None | 17.5 parts | 10.5 parts | 0.7 parts | 0.3 parts | 1 part |
| | particles | | (Isobornyl | (Polyester | | | |
| | 70 parts | | acrylate) | acrylate) | | | |
| 3’ | None | Dendritic silver | 17.5 parts | 10.5 parts | 0.7 parts | 0.3 parts | 1 part |
| | | particles 70 parts | (Isobornyl | (Polyester | | | |
| | | Specific surface area | acrylate) | acrylate) | | | |
| | | 4.19 m²/g | | | | | |
| 4’ | An acrylic series conductive adhesive CA3556HF widely used in the market | | | | | | |
| 5’ | Spherical | Dendritic silver | 17.5 parts | 10.5 parts | 1 part | 0 | 1 part |
| | silver particles | particles 50 parts | (Isobornyl | (Polyester | | | |
| | 20 parts | Specific surface area | acrylate) | acrylate) | | | |
| | | 0.69 m²/g | | | | | |

1′ represents Comparative Example 1; 2′ represents Comparative Example 2; 3′ represents Comparative Example 3; 4′ represents Comparative Example 4; 5′ represents Comparative Example 5

Compared with Embodiment 5, Comparative Example 1 and Comparative Example 2 differ in that, Comparative Example 1 and Comparative Example 2 do not contain three-dimensional dendritic conductive particles; and Embodiment 5 does not contain spherical or flaky conductive particles.

In Comparative Example 3, compared with Embodiment 5, the difference lies in: the specific surface area of the three-dimensional dendritic conductive particles is different. The specific surface area of Embodiment 5 is 0.69 m²/g, which is between 0.2 and 3.5 m²/g. The specific surface area of the three-dimensional dendritic conductive particles of Comparative Example 3 is as high as 4.19 m²/g.

In Comparative Example 5, compared with Embodiment 1, the difference is whether the adhesion promotor contains phosphate ester. The adhesion promoter of Embodiment 1 contains phosphate ester, while the adhesion promoter of Comparative Example 5 does not contain phosphate ester.

The results of the tests performed on the acrylic conductive pastes of the above-mentioned Embodiments 1 to 8 and Comparative Examples 1 to 5 are shown in Table 3. The following conclusions can be drawn from Table 3.

TABLE 3
Test results of Embodiments 1 to 8 (represented by 1 to 8), and Comparative Examples 1 to 5 (represented by 1’ to 5’)

| | Embodiment | | | | | | |
|---|---|---|---|---|---|---|---|
| Test Item | 1 | 2 | 3 | 4 | 5 | 6 | 7 |
| Thermal | 130 ± 20 | 130 ± 20 | 130 ± 20 | 130 ± 20 | 130 ± 20 | 130 ± 20 | 130 ± 20 |
| expansion | | | | | | | |
| coefficient (ppm) | | | | | | | |
| Glass transition | −30 ± 10 | −30 ± 10 | −30 ± 10 | −30 ± 10 | −30 ± 10 | −30 ± 10 | −30 ± 10 |
| temperature (° C.) | | | | | | | |
| Viscosity @26° C. | 30000 | 30000 | 30000 | 30000 | 37000 | 33000 | 37000 |
| (mPa.s) | | | | | | | |
| @150° C. Curing | 15 | 15 | 15 | 15 | 15 | 15 | 15 |
| time (s) | | | | | | | |
| Volume resistivity | 1.3 × 10⁻⁴ | 1.4 × 10⁻⁴ | 1.5 × 10⁻⁴ | 1.5 × 10⁻⁴ | 0.5 × 10⁻⁴ | 0.8 × 10⁻⁴ | 0.75 × 10⁻⁴ |
| (Ω.cm) | | | | | | | |
| Shear strength | 10.8 | 10.5 | 10.5 | 9.8 | 9.6 | 9.3 | 9.6 |
| (MPa) | | | | | | | |
| Printing | good | good | good | good | fair | fair | fair |
| performance | | | | | | | |
| | | Embodiment | | | | | |
| | Test Item | 8 | 1’ | 2’ | 3’ | 4’ | 5’ |
| | Thermal | 130 ± 20 | 130 ± 20 | 130 ± 20 | 130 ± 20 | | 130 ± 20 |
| | expansion | | | | | | |
| | coefficient (ppm) | | | | | | |
| | Glass transition | −30 ± 10 | −30 ± 10 | −30 ± 10 | −30 ± 10 | −30 | −30 ± 10 |
| | temperature (° C.) | | | | | | |
| | Viscosity @26° C. | 39000 | 26000 | 28000 | 53000 | 31500 | 30000 |
| | (mPa.s) | | | | | | |
| | @150° C. Curing | 15 | 15 | 15 | 15 | | 15 |
| | time (s) | | | | | | |
| | Volume resistivity | 0.8 × 10⁻⁴ | 8.2 × 10⁻⁴ | 7.9 × 10⁻⁴ | 15 × 10⁻⁴ | 25 × 10⁻⁴ | 1.3 × 10⁻⁴ |
| | (Ω.cm) | | | | | | |
| | Shear strength | 9.6 | 10.7 | 10.4 | 9.6 | 8.6 | 7.2 |
| | (MPa) | | | | | | |
| | Printing | fair | good | good | poor | good | good |
| | performance | | | | | | |

1) The thermal expansion coefficient and glass transition temperature of Embodiments 1 to 8 and Comparative Examples 1 to 5 are almost the same.

2) Comparing Comparative Example 1 and Comparative Example 2 with Embodiment 5, the viscosity of Comparative Example 1 and Comparative Example 2 is slightly lower than that of Embodiment 5, but all conductive pastes of Comparative Example 1, Comparative Example 2 and Embodiment 5 have good printability, which means that even if the conductive particles in the conductive paste of this embodiment are all three-dimensional dendritic conductive particles, conductive pastes with better printability can still be prepared.

However, the volume resistivity of Comparative Example 1 and Comparative Example 2 is significantly higher than the volume resistivity of Embodiments 1 to 8, indicating that the conductivity of Comparative Example 1 and Comparative Example 2 is poor. If the conductive particles in the conductive paste contains only the spherical conductive articles or flaky conductive particles, the volume resistivity of the conductive paste will increase causing the conductivity to deteriorate. In other words, under a condition that the weight of the conductive particles used is the same, the use of three-dimensional dendritic conductive particles in the conductive paste can reduce the volume resistivity and improve the conductivity.

3) Comparing Comparative Example 3 with Embodiment 5, because of the increase in the specific surface area of the three-dimensional dendritic conductive particles, the volume resistivity of Comparative Example 3 is significantly higher than that of Embodiment 5, and the viscosity is also significantly higher than that of Embodiment 5, which in turn causes printing difficulties. Therefore, to ensure both a good conductivity and a good printability of the conductive paste, the specific surface area of the three-dimensional dendritic conductive particles needs to be restricted between 0.2 and 3.5 m²/g.

4) By comparing Comparative Example 5 with Embodiment 1, it can be found that the lack of phosphate ester in the adhesion promoter will seriously affect the shear strength of the conductive paste. For example, the shear strength of Comparative Example 5 is significantly lower than the shear strength of Embodiment 1.

In an aspect, the present disclosure provides an acrylic conductive paste, based on 100 parts by weight, including 30˜84 parts of conductive particles, 15˜45 parts of acrylate, 0.5˜2.5 parts of adhesion promoter, and 0.5˜3.0 parts of initiator. Among them, the conductive particles include three-dimensional dendritic conductive particles; the adhesion promoter is a mixture of silane coupling agent and phosphate.

In addition, the ratio of a weight of the three-dimensional dendritic conductive particles in the acrylic conductive paste of the present disclosure to a total weight of the conductive particles is one selected from (0.05˜0.95):1, that is, the ratio can be 0.05:1; it can also be 0.95:1; or is any one in between such as 0.5:1. etc.

Although only limited number of embodiments are illustrated above, much more combinations of raw materials with different parts for the conductive particles, acrylate, adhesion promoter, and initiator are selected to be used for forming the acrylic conductive paste of the present disclosure. Optionally, 30˜34 parts of conductive particles are used. Optionally, 34˜39 parts of conductive particles are used. Optionally, 39˜45 parts of conductive particles are used.

Optionally, 45˜51 parts of conductive particles are used. Optionally, 51˜57 parts of conductive particles are used. Optionally, 57˜67 parts of conductive particles are used. Optionally, 67˜73 parts of conductive particles are used. Optionally, 73˜78 parts of conductive particles are used. Optionally, 78˜82 parts of conductive particles are used. Optionally, 82˜84 parts of conductive particles are used. Optionally, 15˜18 parts of acrylate are used. Optionally, 18˜22 parts of acrylate are used. Optionally, 22˜27 parts of acrylate are used. Optionally, 27˜32 parts of acrylate are used. Optionally, 32˜37 parts of acrylate are used. Optionally, 37˜41 parts of acrylate are used. Optionally, 41˜45 parts of acrylate are used. Optionally, 0.5˜0.8 parts of adhesion promoter are used. Optionally, 0.8˜1.1 parts of adhesion promoter are used. Optionally, 1.1˜1.5 parts of adhesion promoter are used. Optionally, 1.5˜1.9 parts of adhesion promoter are used. Optionally, 1.9˜2.2 parts of adhesion promoter are used. Optionally, 2.2˜2.5 parts of adhesion promoter are used. Optionally, 0.5˜0.9 parts of initiator are used. Optionally, 0.9˜1.3 parts of initiator are used. Optionally, 1.3˜1.8 parts of initiator are used. Optionally, 1.8˜2.3 parts of initiator are used. Optionally, 2.3˜2.7 parts of initiator are used. Optionally, 2.7˜3.0 parts of initiator are used.

In some embodiments, the three-dimensional dendritic conductive particles are characterized by a specific surface area limited in a range of 0.2˜3.5 m²/g. Because the specific surface area affects the conductivity of the conductive paste, so the specific surface area of the three-dimensional dendritic conductive particles in the acrylic conductive paste of the present disclosure is limited in the range of 0.2˜3.5 m²/g. In order to meet the application of the acrylic conductive paste in different scenarios, the three-dimensional dendritic conductive particles are characterized by an average particle diameter or median diameter D50 which is usually set in a range of 0.1 μm˜50 μm.

In some embodiments, the three-dimensional dendritic conductive particles in the acrylic conductive paste of the present disclosure are three-dimensional dendritic silver particles and/or three-dimensional dendritic silver-coated copper particles. Optionally, the three-dimensional dendritic conductive particles can be three-dimensional dendritic silver particles, or three-dimensional dendritic silver-coated copper particles, or a mixture of three-dimensional dendritic silver particles and three-dimensional dendritic silver-coated copper particles.

If a conductive paste contains only three-dimensional dendritic conductive particles, it may cause the viscosity to increase, and even affect the printability of the conductive paste. Therefore, in order to ensure that under the condition of no significant change of the conductivity, the viscosity of the conductive paste is reduced with enhanced printability by including at least 5% of one or a combination of more of spherical conductive particles, flaky conductive particles, or spheroidal conductive particles in the conductive particles with three-dimensional dendritic structures.

In a specific embodiment, the conductive particles are a mixture of spherical silver particles and three-dimensional dendritic silver particles, and the ratio of the weight of the three-dimensional dendritic silver particles to the total weight of the conductive particles is one selected from (0.05˜0.95):1. The ratio of the weight of the three-dimensional dendritic silver particles to the total weight of the conductive particles can be 0.05:1; or 0.95:1; or any one in between such as 0.5:1, etc. The three-dimensional dendritic silver particles are characterized by a specific surface area limited in a range of 0.2˜3.5 m²/g, and the spherical silver particles are characterized by particle sizes selected from a range of 0.1 μm˜50 μm. The size of the spherical silver particles can be selected from 0.1 μm˜50 μm according to actual needs. For example, it can be 0.1 μm, or 30 μm, or 50 μm, etc.

In a specific embodiment, the conductive particles are a mixture of spherical silver particles and three-dimensional dendritic silver-coated copper particles, and the ratio of the weight of the three-dimensional dendritic silver-coated copper particles to the total weight of the conductive particles is one selected from (0.05˜0.95):1. The three-dimensional dendritic silver-coated copper particles are characterized by a specific surface area limited in a range of 0.2˜3.5 m²/g, and the spherical silver particles are characterized by particle sizes selected from a range of 0.1 μm˜50 μm. Optionally, the ratio of the weight of the three-dimensional dendritic silver-coated copper particles to the total weight of the conductive particles can be 0.05:1; or 0.95:1; or any one in between such as 0.5:1, etc. The size of the spherical silver particles can be selected from the range of 0.1˜50 μm according to actual needs. For example, it can be selected to be 0.1 μm, or 30 μm, or 50 μm, etc.

In a specific embodiment, the conductive particles are a mixture of flaky silver particles and three-dimensional dendritic silver particles. The ratio of a weight of the three-dimensional dendritic silver particles to the total weight of the conductive particles is one selected from (0.05˜0.95):1. The three-dimensional dendritic silver particles are characterized by a specific surface area limited in a range of 0.2˜3.5 m²/g, and the flaky silver particles are characterized by particle sizes selected from 0.1 μm˜50 μm. That is, the ratio of the weight of the three-dimensional dendritic silver particles to the total weight of the conductive particles can be 0.05:1; or 0.95:1; or any one in between such as 0.5:1, etc. The size of the flaky silver particles can be selected from 0.1˜50 μm according to actual needs at 0.1 μm, or 30 μm, or 50 μm, etc.

In a specific embodiment, the conductive particles are a mixture of flaky silver particles and three-dimensional dendritic silver-coated copper particles, and the ratio of the weight of the three-dimensional dendritic silver-coated copper particles to the total weight of the conductive particles is one selected from a range of (0.05˜0.95):1. The three-dimensional dendritic silver-coated copper particles are characterized by a specific surface area limited in a range of 0.2˜3.5 m²/g, and the flaky silver particles are characterized by particle sizes selected from 0.1 μm˜50 μm. Optionally, the ratio of the weight of the three-dimensional dendritic silver-coated copper particles to the total weight of the conductive particles can be 0.05:1; or 0.95:1; or any one in between such as 0.5:1, etc. The size of the flaky silver particles can be selected from 0.1 μm˜50 μm based on actual needs, for example, 0.1 μm, or 30 μm, or 50 μm,

In a specific embodiment, the conductive particles are a mixture of flaky silver-coated copper particles and three-dimensional dendritic silver-coated copper particles. The weight of the three-dimensional dendritic silver-coated copper particles is the ratio of the total weight of the conductive particles selected from a range of (0.05˜0.95):1. The three-dimensional dendritic silver-coated copper particles are characterized by a specific surface area limited in a range of 0.2˜3.5 m²/g, and the flaky silver-coated copper particles are characterized by particle sizes selected from 0.1 μm˜50 That is, the ratio of the weight of the three-dimensional dendritic silver-coated copper particles to the total weight of the conductive particles can be 0.05:1; or 0.95:1; or any one in between such as 0.5:1, etc. The size of the flaky silver-coated copper particles can be based on actual need to choose. For example, it can be 0.1 it can be 50 it can also be 30 etc.

In a specific embodiment, the conductive particles are a mixture of spherical silver-coated copper particles and three-dimensional dendritic silver-coated copper particles, and the ratio of the weight of the three-dimensional dendritic silver-coated copper particles to the total weight of the conductive particles is one selected from a range of (0.05˜0.95):1. The three-dimensional dendritic silver-coated copper particles are characterized by a specific surface area limited in a range of 0.2˜3.5 m²/g, and the spherical silver-coated copper particles are characterized by particle sizes selected from 0.1 μm˜50 That is, the ratio of the weight of three-dimensional dendritic silver-coated copper particles to the total weight of conductive particles can be 0.05:1; it can also be 0.95:1; it can also be 0.5:1, etc. The size of spherical silver-coated copper particles can be based on actual need to choose from, for example, 0.1 μm, 50 μm, or any one in between such as 30 etc.

Further, in a specific embodiment, the conductive particles are a mixture of three-dimensional dendritic silver particles and three-dimensional dendritic silver-coated copper particles, and the ratio of the weight of the three-dimensional dendritic silver-coated copper particles to the total weight of the conductive particles is one selected from (0.05˜0.95):1. The three-dimensional dendritic silver particles are characterized by a specific surface area limited in a range of 0.2˜3.5 m²/g, and the three-dimensional dendritic silver-coated copper particles are characterized by a specific surface area limited in a range of 0.2˜3.5 m²/g. That is, the ratio of the weight of the three-dimensional dendritic silver-coated copper particles to the total weight of the conductive particles can be 0.05:1; it can also be 0.95:1; or it can also be any one between 0.05:1 and 0.95:1 such as 0.5:1, etc. The specific surface area of the three-dimensional dendritic silver particles or three-dimensional dendritic silver-coated copper particles can be 0.2 m²/g, 3.5 m²/g, or any one in between such as 2.0 m²/g, etc.

Further, in some embodiments, the particle size of the three-dimensional dendritic silver particles in the acrylic conductive paste of the present disclosure is selected from a range of 0.2 μm˜50 μm.

Further, in some embodiments, the particle size of the three-dimensional dendritic silver-coated copper particles in the acrylic conductive paste of the present disclosure is selected from a range of 0.2 μm˜50 μm.

Further, the acrylate in the acrylic conductive paste of the present disclosure is a mixture of acrylate monomers and acrylate oligomers. Optionally, the ratio of the weight of acrylate monomers to the total weight of acrylate is one selected from (0.1˜0.9):1. Because the acrylate is cured to form an acrylic resin, and the acrylic resin has good mechanical properties and weather resistance, and exhibits excellent performance in a high temperature and high humidity environment, so it can interact with semiconductor components and substrates. The conductive paste of the present disclosure demonstrates good adhesion and improvement in weather resistance.

In addition, it is also noted that the ratio of the weight of the acrylate monomers of the present disclosure to the total weight of the acrylate can be 0.1:1; or 0.9:1; or any one in between such as 0.625:1, etc.

Further, the acrylate monomers in the acrylic conductive paste of the present disclosure are one or more of isobornyl acrylate, isobornyl methacrylate, ethoxyethoxyethyl acrylate, lauric acid acrylate, tetrahydrofurfuryl acrylate, or 2-phenoxy ethyl acrylate. In the specific embodiment, the acrylate monomers can be any one kind of the above-mentioned multiple kinds of monomers, or it can be any two or a combination of two or more of the above-mentioned monomers.

Acrylate oligomers in the acrylic conductive paste of the present disclosure are one or more of polyester acrylate and aliphatic polyurethane acrylic oligomers. In some embodiments, the acrylate oligomers can be polyester acrylate, or any aliphatic polyurethane acrylic oligomers. Or, the acrylate oligomers include polyester acrylate or any one or more aliphatic polyurethane acrylic oligomers.

For example, the aliphatic urethane acrylic oligomers used in the specific embodiments can be the aliphatic urethane acrylic oligomers with the brand name CN8881NS purchased from Sartomer (Guangzhou) Chemical Co., Ltd., or aliphatic polyurethane acrylic oligomers with the brand number CN9014NS purchased from Sartomer (Guangzhou) Chemical Co., Ltd.

Furthermore, in the adhesion promoter of the acrylic conductive paste, the ratio of the weight of the phosphate to the total weight of the adhesion promoter is one selected from (0.1˜0.5):1; indicating the weight of the phosphate and the total weight of the adhesion promoter can be 0.1:1; or 0.5:1; or any one in between such as 0.3:1, etc. The role of the adhesion promoter is to further increase the adhesion between the conductive paste and the bonding substrate.

Furthermore, the alkane coupling agent in the acrylic conductive paste of the present disclosure is one or a combination of more of 3-methacryloxypropyldimethoxysilane, 3-methacryloxypropyltrimethoxysilane, 3-methacryloxypropyldimethoxysilane, and 3-methacryloxypropyldimethoxysilane. Ethoxysilane, 3-methacryloxypropyltriethoxysilane, vinyltrimethoxysilane, vinyltriethoxysilane, styrene trimethoxysilane, or 3-methacryloxypropyltriethoxysilane. Phosphate is one or a combination of more of 2-hydroxyethyl methacrylate phosphate, trifunctional acrylate phosphate, alkyl acrylate phosphate, or trifunctional acrylate phosphate.

Furthermore, the initiator in the acrylic conductive paste of the present disclosure is one of a combination of more of tert-butyl peroxide neodecanoate, tert-butyl peroxide 2-ethylhexyl acid, 1,1′-bis(tert-butylperoxy)-3,3,5-trimethyl ring hexane or 1,1′-bis(tert-amylperoxy)cyclohexane. That is, in the specific embodiment, the initiator can be selected from one or more of the above listed initiators according to actual needs. The purpose of the initiator is to initiate a curing reaction of the conductive paste during its application.

Furthermore, the conductive particles in the acrylic conductive paste of the present disclosure include one or a combination of two of silver particles or silver-coated copper particles.

In a specific embodiment, the conductive particles in the acrylic conductive paste of the present disclosure include one or a combination of more of three-dimensional dendritic silver particles, spherical silver particles, flaky silver particles or spheroidal silver particles.

In a specific embodiment, the conductive particles in the acrylic conductive paste of the present disclosure include one or a combination of more of three-dimensional dendritic silver particles, spherical silver-coated copper particles, flaky silver-coated copper particles, or spheroidal silver-coated copper particles.

In a specific embodiment, the conductive particles in the acrylic conductive paste of the present disclosure include one of a combination of more of three-dimensional dendritic silver-coated copper particles, spherical silver-coated copper particles, flaky silver-coated copper particles, or spheroidal silver-coated copper particles.

In a specific embodiment, the conductive particles in the acrylic conductive paste of the present disclosure include one or a combination of more of three-dimensional dendritic silver-coated copper particles, spherical silver particles, flaky silver particles, or spheroidal silver particles.

In a specific embodiment, the conductive particles in the acrylic conductive paste of the present disclosure include one or a combination of more of three-dimensional dendritic silver-coated copper particles, three-dimensional dendritic silver particles, and spherical silver-coated copper particles, flaky silver-coated copper particles, spheroidal silver-coated copper particles, spherical silver particles, and flaky silver particles or spherical silver particles.

In another aspect, the present disclosure also provides a method for preparing the acrylic conductive paste described herein. The method includes the following steps:

S1, based on 100 parts of total weight, weighing 30˜84 parts of conductive particles, 15˜45 parts of acrylate, 0.5˜2.5 parts of adhesion promoter and 0.5˜3.0 parts of initiator; wherein, the conductive particles include three-dimensional dendritic conductive particles, and the adhesion promoter is a mixture of a silane coupling agent and a phosphate ester. It is noted that weighing raw materials may have about 10% error margin.

S2, disposing the acrylate, the adhesion promoter, and the initiator according to weighted parts above in a reactor and stirring evenly, then adding the conductive particles of the weighted parts and stirring evenly to obtain a mixture.

S3, grinding the mixture to obtaining the acrylic conductive paste described herein.

In yet another aspect, the present disclosure also provides an application method of the above-mentioned acrylic conductive paste to semiconductor components for packaging a semiconductor device. In a specific application, using the acrylic conductive paste of the present disclosure includes printing the acrylic conductive paste on a substrate of the semiconductor component, and disposing the substrate printed with the acrylic conductive paste in an environment of 80° C. to 170° C. (for example, 150° C.), to cure for 5-300 s (for example, 15 s) to obtain a semiconductor component applied with the acrylic conductive paste of the present disclosure. The application method further includes packaging the semiconductor component into a semiconductor device.

In summary, because the conductive particles of the conductive paste according to some embodiments of the present disclosure include three-dimensional dendritic conductive particles, the two-point contact between the two conductive particles becomes multi-point contact. Therefore, when the amount of conductive particles used in the conductive paste is the same, the volume resistivity of the conductive paste according to some embodiments of the present disclosure can be greatly reduced to improve the conductivity. Accordingly, the cost of making the conductive paste is reduced. Because the conductive paste according to some embodiments of the present disclosure also contains acrylate combined with the adhesion promoter, that is a mixture of silane coupling agent and phosphate ester, the conductive paste has characteristic of fast curing speed and strong adhesion, and can be used in long-term operation at room temperature.

The present disclosure has been described in detail with reference to preferred embodiments above, which however are not intended to limit the present disclosure. Any modifications, equivalent substitutions and improvements can be made without departing from the spirit and principle of the present disclosure, which are all fall within the protection scope of the present disclosure.

What is claimed is:

1. An acrylic conductive paste comprising, based on 100 parts by weight,
30˜84 parts of conductive particles;
15˜45 parts of acrylate;
0.5˜2.5 parts of adhesion promoter; and
0.5˜3.0 parts of initiator;
wherein the conductive particles comprise three-dimensional dendritic conductive particles, and the adhesion promoter is a mixture of a silane coupling agent and a phosphate ester.

2. The acrylic conductive paste of claim 1, wherein the three-dimensional dendritic conductive particles are characterized by a specific surface area of 0.2˜3.5 m²/g.

3. The acrylic conductive paste of claim 2, wherein the three-dimensional dendritic conductive particles comprise three-dimensional dendritic silver particles and/or three-dimensional dendritic silver-coated copper particles.

4. The acrylic conductive paste of claim 1, wherein the conductive particles comprise a mixture of spherical silver particles and three-dimensional dendritic silver particles, and a ratio of a weight of the three-dimensional dendritic silver particles to a total weight of the conductive particles is one selected from (0.05 to 0.95):1, the three-dimensional dendritic silver particles are characterized by a specific surface area in a range of 0.2˜3.5 m²/g, and the spherical silver particles are characterized by a size in a range of 0.1˜50 μm.

5. The acrylic conductive paste of claim 1, wherein the conductive particles comprise a mixture of spherical silver particles and three-dimensional dendritic silver-coated copper particles, and a ratio of a weight of the three-dimensional dendritic silver-coated copper particles to a total weight of the conductive particles is one selected from (0.05 to 0.95):1, the three-dimensional dendritic silver-coated copper particles are characterized by a specific surface area in a range of 0.2˜3.5 m²/g, and the spherical silver particles are characterized by a size in a range of 0.1˜50 μm.

6. The acrylic conductive paste of claim 1, wherein the conductive particles comprise a mixture of flaky silver particles and three-dimensional dendritic silver particles, a ratio of a weight of the three-dimensional dendritic silver particles to a total weight of the conductive particles is one selected from (0.05 to 0.95):1, the three-dimensional dendritic silver particles are characterized by a specific surface area in a range of 0.2˜3.5 m²/g, and the flaky silver particles are characterized by a size in a range of 0.1˜50 μm.

7. The acrylic conductive paste of claim 1, wherein the conductive particles comprise a mixture of flaky silver particles and three-dimensional dendritic silver-coated copper particles, and a ratio of a weight of the three-dimensional dendritic silver-coated copper particles to a total weight of the conductive particles is one selected from (0.05 to 0.95):1, the three-dimensional dendritic silver-coated copper particles are characterized by a specific surface area in a range of 0.2˜3.5 m²/g, and the flaky silver particles are characterized by a size in a range of 0.1˜50 μm.

8. The acrylic conductive paste of claim 1, wherein the conductive particles comprise a mixture of flaky silver-coated copper particles and three-dimensional dendritic silver-coated copper particles, and a ratio of a weight of the three-dimensional dendritic silver-coated copper particles to a total weight of the conductive particles is one selected from (0.05 to 0.95):1, the three-dimensional dendritic silver-coated copper particles are characterized by a specific surface area in a range of 0.2˜3.5 m²/g, and the flaky silver-coated copper particles are characterized by a size in a range of 0.1˜50 μm.

9. The acrylic conductive paste of claim 1, wherein the conductive particles comprise a mixture of spherical silver-coated copper particles and three-dimensional dendritic silver-coated copper particles, and a ratio of a weight of the three-dimensional dendritic silver-coated copper particles to a total weight of the conductive particles is one selected from (0.05 to 0.95):1, the three-dimensional dendritic silver-coated copper particles are characterized by a specific surface area in a range of 0.2˜3.5 m²/g, and the spherical silver-coated copper particles characterized by a size in a range of 0.1˜50 μm.

10. The acrylic conductive paste of claim 1, wherein the conductive particles comprise a mixture of three-dimensional dendritic silver particles and three-dimensional dendritic silver-coated copper particles, and a ratio of a weight of the three-dimensional dendritic silver-coated copper particles to a total weight of the conductive particles is one selected from (0.05 to 0.95):1, the three-dimensional dendritic silver particles are characterized by a specific surface area in a range of 0.2˜3.5 m²/g, and the three-dimensional dendritic silver-coated copper particles are characterized by a specific surface area in a range of 0.2˜3.5 m²/g.

11. The acrylic conductive paste of claim 3, wherein the three-dimensional dendritic silver particles are characterized by a size in a range of 0.2˜50 μm.

12. The acrylic conductive paste of claim 3, wherein the three-dimensional dendritic silver-coated copper particles are characterized by a size in a range of 0.2˜50 μm.

13. The acrylic conductive paste of claim 1, wherein the acrylate comprises a mixture of acrylate monomers and acrylate oligomers with a weight ratio of the acrylate monomers over the acrylate in a range of (0.1 to 0.9):1.

14. The acrylic conductive paste of claim 13, wherein the acrylate monomers comprise one or a combination of isobornyl acrylate, isobornyl methacrylate, ethoxy ethyl acrylate, lauric acid acrylate, tetrahydrofurfuryl acrylate, or 2-phenoxy ethyl acrylate.

15. The acrylic conductive paste of claim 13, wherein the acrylate oligomers comprise one or a combination of polyester acrylate and aliphatic polyurethane acrylic oligomers.

16. The acrylic conductive paste of claim 1, wherein the adhesion promoter comprises the phosphate ester with a weight ratio limited in a range of (0.1 to 0.5):1.

17. The acrylic conductive paste of claim 16, wherein the silane coupling agent comprises one or a combination of 3-methacryloxypropyldimethoxysilane, 3-methacryloxypropyltrimethoxysilane, 3-methacryloxypropyl diethyl Oxysilane, 3-methacryloxypropyltriethoxysilane, vinyltrimethoxysilane, vinyltriethoxysilane, styrene trimethoxysilane, or 3-acrylic propyltrimethoxysilane;
the phosphate ester comprises one or a combination of 2-hydroxyethyl methacrylate phosphate, trifunctional acrylate phosphate, alkyl acrylate phosphate, or trifunctional acrylate phosphate.

18. The acrylic conductive paste of claim 1, wherein the initiator comprises one or a combination of tert-butyl peroxide neodecanoate, tert-butyl peroxide 2-ethylhexyl acid, 1,1′-bis(tert-butylperoxy)-3,3,5-trimethylcyclohexane Alkane, or 1,1′-bis(tert-amylperoxy)cyclohexane.

19. A method for preparing the acrylic conductive paste according to claim 1, comprising:
weighing, based on the total weight of 100 parts, 30-84 parts of conductive particles, 15-45 parts of acrylate, 0.5-2.5 parts of adhesion promoter, and 0.5-3 parts of initiator; wherein the conductive particles include three-dimensional dendritic conductive particles, and the adhesion promoter is a mixture of a silane coupling agent and a phosphate ester;
disposing the acrylate, the adhesion promoter, and the initiator in a reactor;
stirring the acrylate, the adhesion promoter, and the initiator in a reactor evenly;
adding the conductive particles into the reactor;
stirring the conductive particles as well as the acrylate, the adhesion promoter, and the initiator evenly to obtain a mixture; and
grinding the mixture to obtain the acrylic conductive paste.

20. A method of using the acrylic conductive paste according to claim 1 comprising:
applying the acrylic conductive paste on a substrate of a semiconductor element;
disposing the substrate on which the acrylic conductive paste is applied in an environment of 80° C. to 170° C.;
curing the acrylic conductive paste on the substrate at 150° C. for 5 to 300 seconds; and
packaging the semiconductor element via the acrylic conductive paste into a semiconductor device.
